(19) United States
(12) Patent Application Publication
(10) Pub. No.: US 2015/0156117 A1
(43) Pub. Date: Jun. 4, 2015

(54) HIGH DENSITY SERVER SYSTEM

(71) Applicants: INVENTEC (PUDONG) TECHNOLOGY CORPORATION, Shanghai (CN); INVENTEC CORPORATION, Taipei (TW)

(72) Inventor: Zhiqiang ZHAO, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/254,249

(22) Filed: Apr. 16, 2014

(30) Foreign Application Priority Data
Nov. 29, 2013 (CN) 201310631348.6

(51) Int. Cl. H04L 12/803

(52) U.S. Cl. CPC H04L 47/125

(57) ABSTRACT

A high density server system is disclosed, each of the server nodes on the node back plate and the midplane is established with its separate information transmission channels without any interference to one another, assuring that the network of every such node has a sufficient bandwidth. For those management traffic network signals having a relatively smaller data amount, tracks are incorporated, assuring the technical efficacies of assuring a network transmission speed of the overall server and reducing a space taken up by the transmission tracks.

### BACKGROUND OF THE RELATED ART

1. Technical Field

The present invention is related to a high density server system, and particularly to a high density server system associated with its internal distribution and processes for external network messages.

2. Related Art

A high density server system refers to a server having a high density of server nodes distributed therein for enhancement of the overall operational capability.

A server generally comprises a work network and a management network, the former being involved with transmission of its main service information while the latter being disposed inside a machine room for management and control for itself.

Typically, a high density server transmits information with respect to the external devices through a network interface and has a huge amount of internal nodes but merely some work interfaces to the external, much fewer than the node number of itself, in which the nodes have each to be connected to the management and work networks.

Therefore, it is very an issue for a high density server system to have its every node possessing a reliable network connection and sufficient network bandwidth.

In view of the above, there is quite a need to propose a novel high density server system to overcome the issue of traffic network signal transmission for all the nodes in the same system.

### SUMMARY

A high density server system according to the present invention, comprising a chassis, a midplane, fixed within the chassis and having a plurality of back plate slots, a management network slot, a traffic network slot, and a plurality of signal conductive tracks, each of the plurality back plate slots comprising a plurality sets of traffic network channel pins and a set of management network channel pins, the signal conductive tracks connecting the plurality sets of traffic network channel pins with the traffic network slot to create a plurality of traffic network channels, and connecting the set of management network channel pins with the management network slot to generate a management network channel which is isolated form the traffic network channels; a network control plane, at least having an external network interface, a network processing network, a management network connector and a work network connector, the management network connector and the work network connector being plugged into the management network slot and traffic network slot, respectively, the network processing unit outputting a work traffic network signal and a management traffic network signal through the work network connector and the management network connector to the work network channel and management network channel after receiving the work traffic network signal and management traffic network signal from the external network interface, and further receiving the work traffic network signal and the management traffic network signal from the work network channel and the management network channel and outputting the traffic network signal and the management traffic network signal through the external network interface; a plurality of node backplanes, each being plugged into one of the plurality of back plate slots corresponding thereto, and each comprising a plurality of node slots and a track splitter unit, each of the plurality of node slots being coupled individually to the work network channel corresponding thereto within the back plate slot, the management network channel within the back plate slot being coupled to each of the plurality of node slots through the track splitter unit; and a plurality of server nodes, each being plugged into one of the plurality of node slots corresponding thereto, comprising an data processing unit and a baseboard management controller, the data processing unit receiving and transmitting the work traffic network signal within the work network channel through the one of the plurality of node slots corresponding thereto and the baseboard management controller receiving and transmitting the management network signal by the management network channel through the one of the plurality of node slots corresponding thereto.

In the high density server system, for those work networks having a relatively larger load, each of the server nodes on the node back plate and the midplane has its separate information transmission channel without any interference to one another, assuring that the network of every such node has a sufficient bandwidth and the sever has an guaranteed network transmission speed. For those management networks having a relatively smaller data amount, the server adopts an appropriate track-incorporation means, reducing a space taken up by the transmission tracks. In the traffic network signal transmission within the overall server, the slot interfaces and printed circuits are employed instead of any cable, the elements therein are arranged in a higher density and the signal transmission therein is more reliable.

### BRIEF DESCRIPTION OF THE DRAWINGS

The invention will become more fully understood from the detailed description given herein below illustration only, and thus is not limitative of the present invention, and wherein:

FIG. 1A is a schematic diagram illustrating elements of a high density server according to the present invention;

FIG. 1B is a schematic diagram illustrating elements of a midplane according to the present invention;

FIG. 1C is a schematic diagram illustrating elements of a network control plane according to the present invention;

FIG. 1D is a schematic diagram illustrating elements of a node back plate according to the present invention;

FIG. 1E is a schematic diagram illustrating elements of a midplane according to the present invention; and

FIG. 1F is a schematic diagram illustrating elements of a server node according to the present invention.

### DETAILED DESCRIPTION OF THE INVENTION

The present invention will be apparent from the following detailed description, which proceeds with reference to the accompanying drawings, wherein the same references relate to the same elements.

In the following, the context is contributed to describe the present invention in details in connection with the annex drawings and the embodiments with respect to the features and implementations thereof, which is sufficient to enable those who skilled in the art readily to realize the technical mechanism intent to solve the technical problems and implement the same, so as to achieve in the efficacy exclaimed in the present invention.

In the present invention, a management module may distribute IP addresses according to network identification information and swap information with a plurality of server nodes through a communication module of a high density server, so that the management module may manage the server nodes plugged within the high density server.

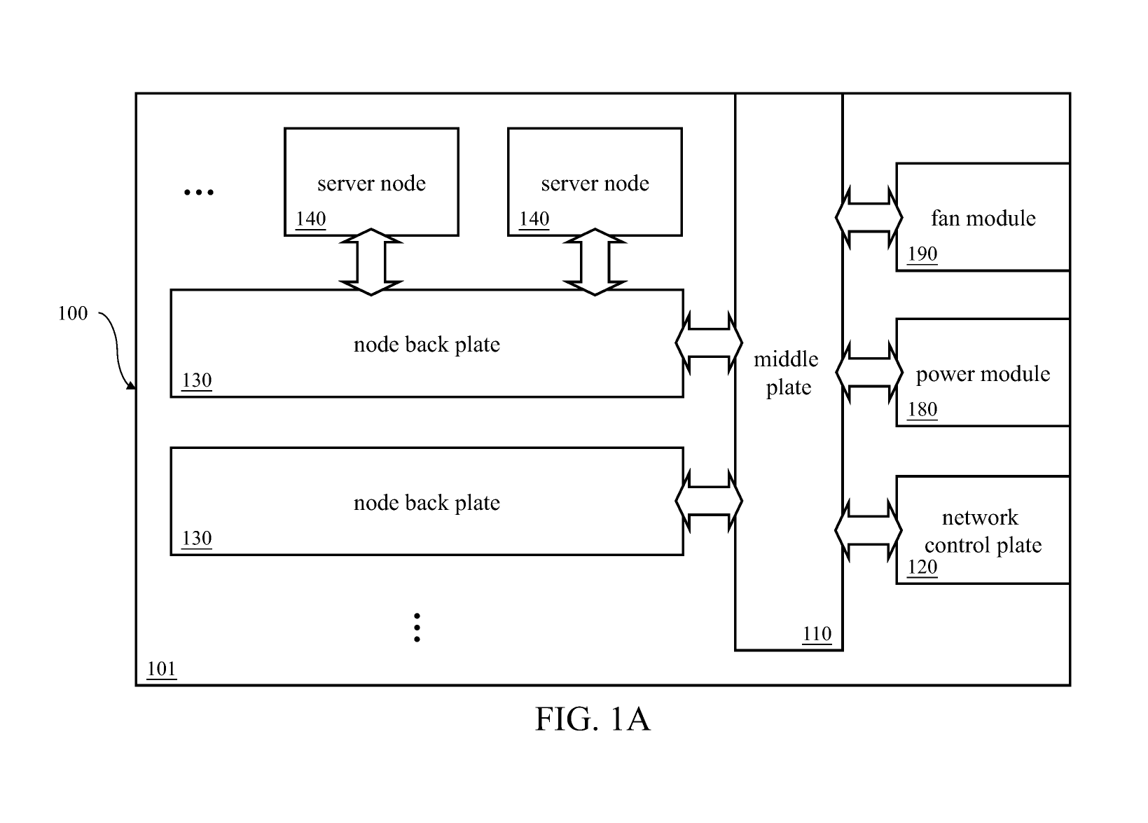

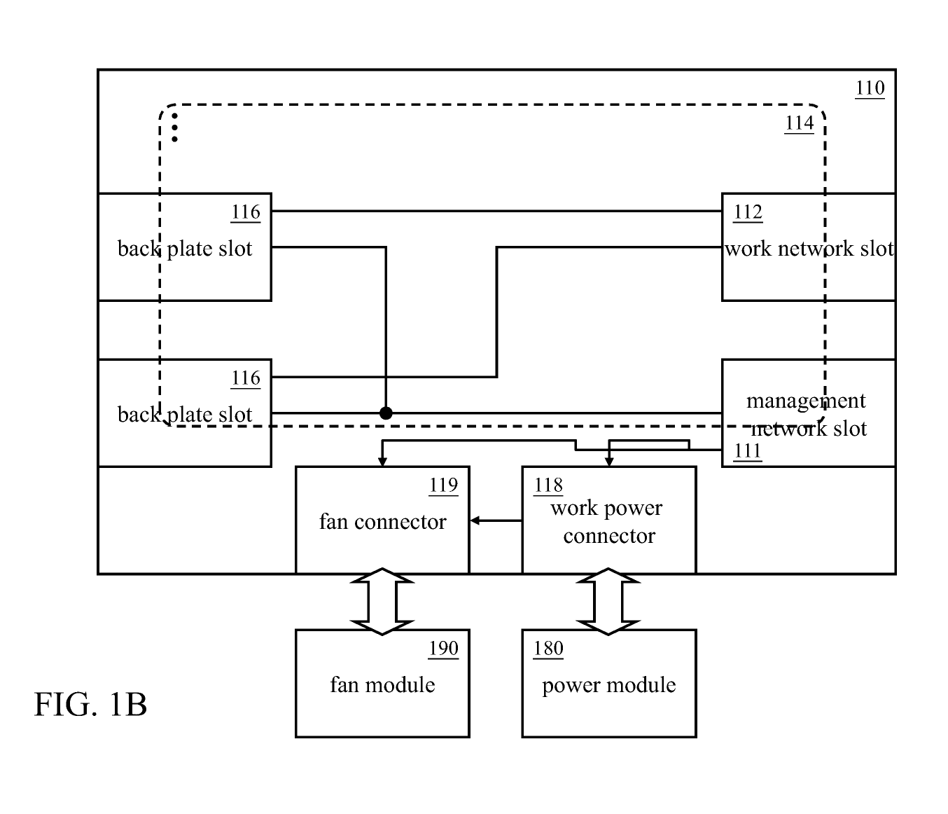

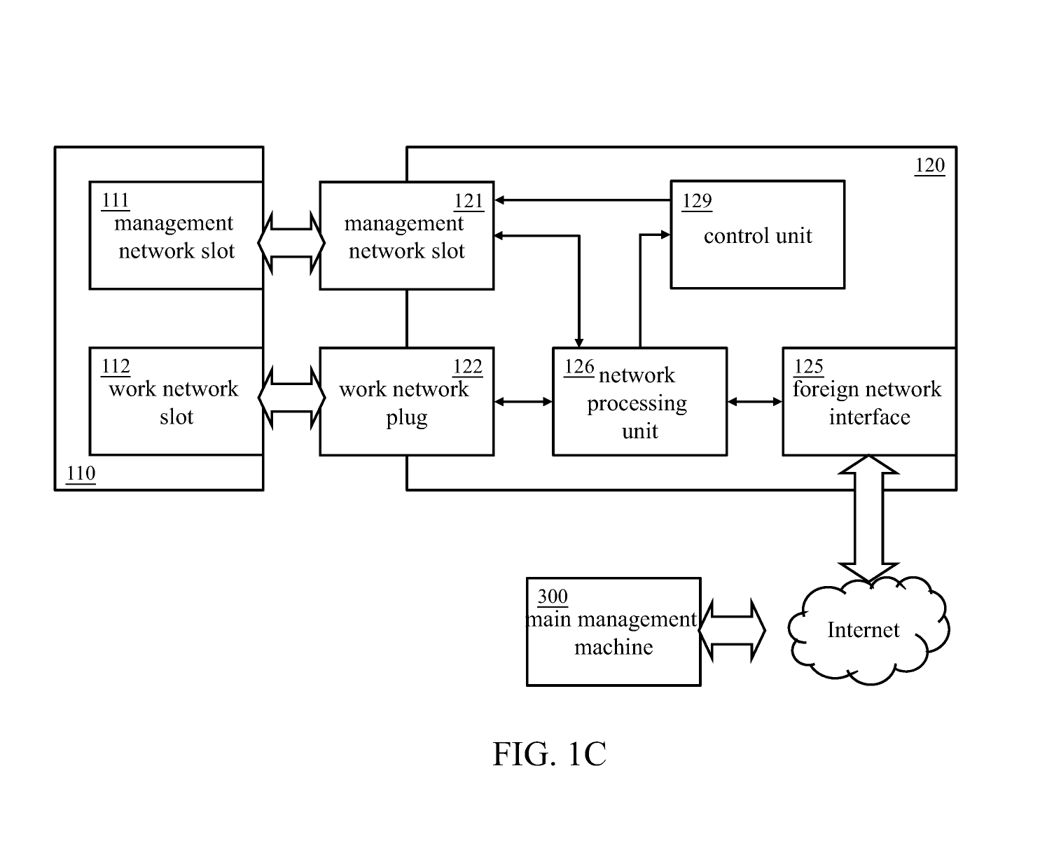

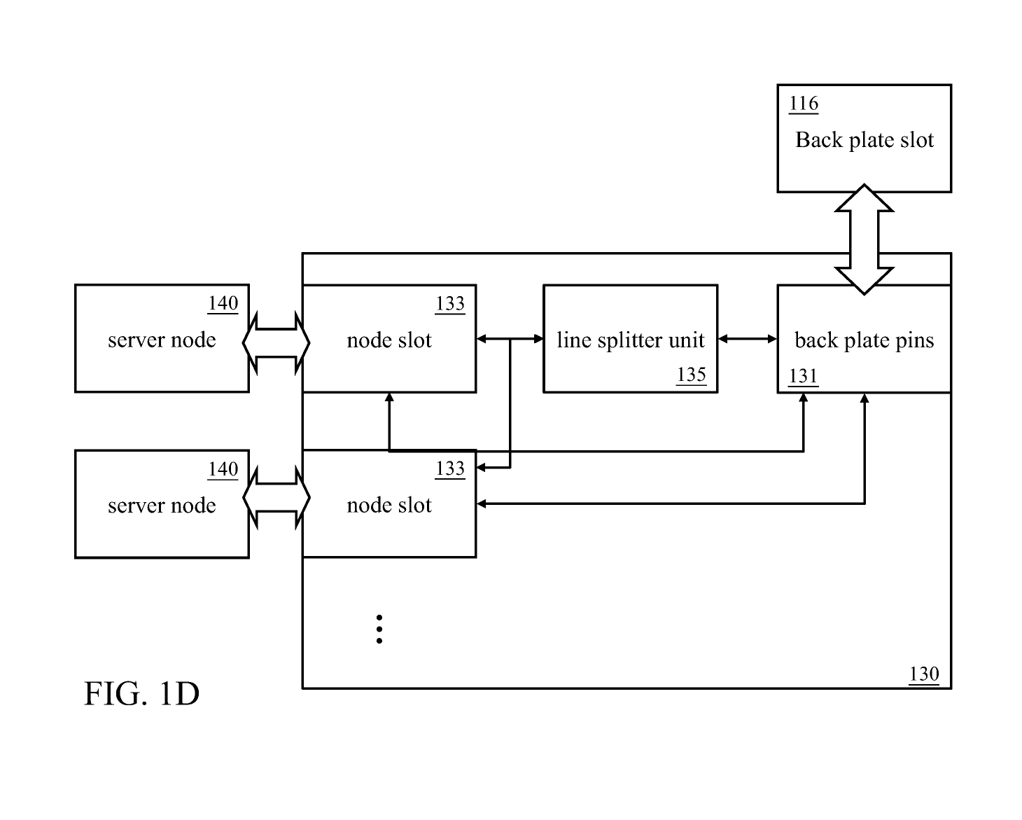

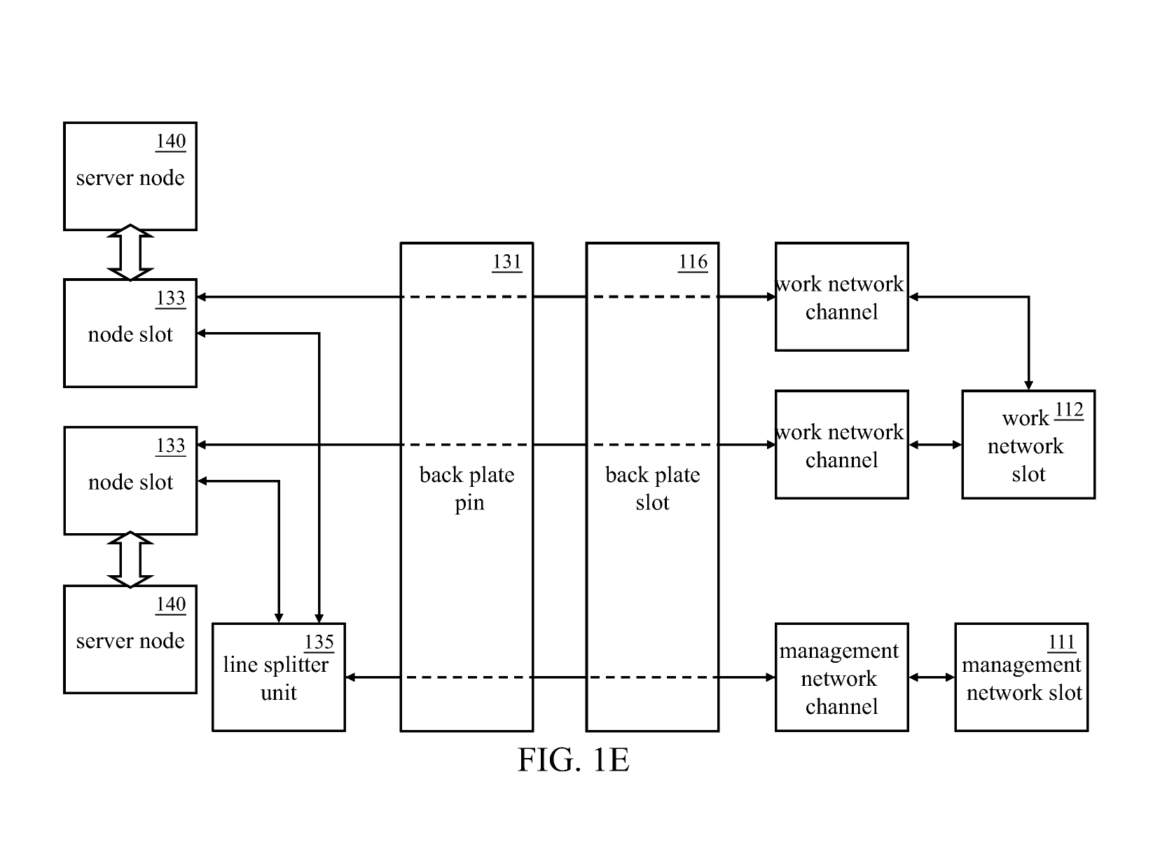

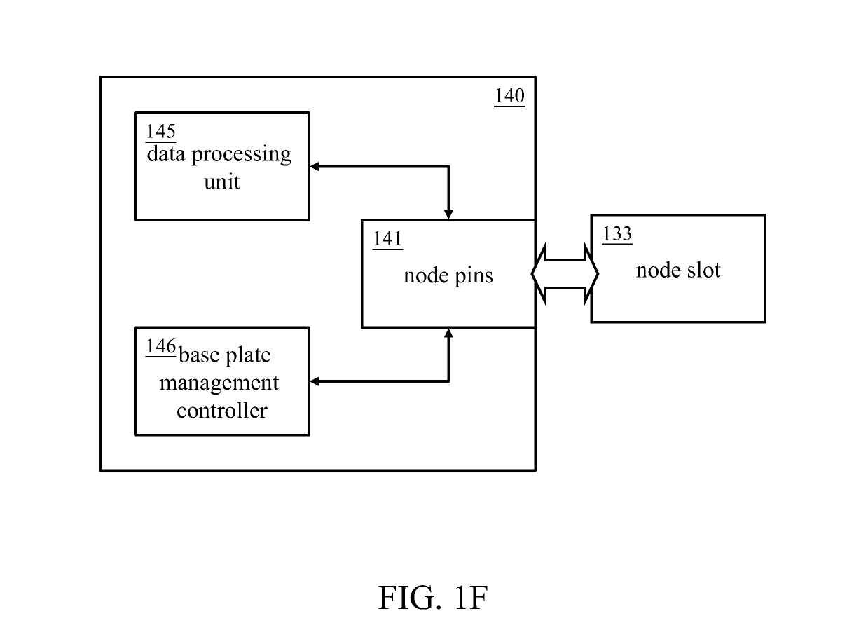

The high density server according to the present invention is shown as FIG. 1A. The high density server 100 at least comprises a chassis 101, a midplane 110, a network control plane 120, a node back plate 130, and server nodes 140. In addition, the high density server 100 may further comprises a power module 180 and a fan module 190.

The chassis 101 provides a space for receiving a middle 110, a network control plane 120, a node back plate 130 and a server node 140 therein.

The midplane 110 is fixed within the chassis 101 for connecting the network control plane 120 with the node back plate 130, and provides a transmission of data information and control signals, etc. In some embodiments, the midplane 110 provides a power signal provided from a power module 180 to the network control plane 120, the node back plate 130, the server node 140, and the fan module 190.

As shown in FIG. 1B, the midplane 110 has a management network slot 111, a traffic network slot 112, signal conductive tracks 114, and a plurality of back plate slots 116. In some embodiments, the midplane 110 further comprises a work power connector 118 and a fan connector 119.

The management network slot 111 and the traffic network slot 112 provide a connection for the network control plane 120 to insert into the midplane 110, and transmit a management traffic network signal and a work traffic network signal from the signal conductive tracks 114 to the network control plane 120, respectively, and also transmit a management traffic network signal and a work traffic network signal to the signal conductive tracks 114 and further to the back plate slot 116.

Each of the plurality back plate slots 116 may be connected with a different node back plate 130. Such back plate slot 116 comprises a plurality sets of traffic network channel pins and a set of management network channel pins (now shown). Each of the sets of traffic network channel pins and management network channel pins includes one or more pins, without any limitation in the present invention.

The signal conductive tracks 114 connects the plurality sets of traffic network channel pins with the traffic network slot 112, to generate a plurality of traffic network channels corresponding to the plurality of traffic network channel pins. The signal conductive tracks 114 also connect the set of management network channel pins with the management network slot 111, to generate a management network channel. The sets of work traffic network channels and management traffic network channels are each isolated to one another.

The work power connector 118 provides a connection for the power module 180, so that the power module 180 may provides a power signal to the node back plate 130 through the middle 110, and then to the server nodes 140. The work power connector 118 is also connected to the fan connector 119, so that the power module 180 may provide a power signal to the fan module 190.

The network control plane 120 is plugged at a side of the midplane 110 for the high density server 100 to swap information with other devices external thereto.

As shown in FIG. 1C, the network control plane 120 comprises a management network connector 121, a work network connector 122, an external network interface 125, and a network processing unit 126. In some embodiments, the network control plane 120 may further comprise a control unit 129.

The management network connector 121 and the work network connector 122 are plugged into the management network slot 111 and the traffic network slot 112, respectively, so that the network control plane 120 is plugged on the midplane 110.

The external network interface 125 is connected to external network devices to the high density server 110, and transmits the management traffic network signal and the work traffic network signal through the management network connector 121 and the work network connector 122, respectively to the external network devices. The external network interface 125 also receives the management traffic network signal and work traffic network signal transmitted from the external network devices. The external device to the high density server 100 may be a management host 300, without limiting the present invention.

After the network processing unit 126 receives the work traffic network signal and/or the management traffic network signal from an external network device, it transmits the management traffic network signal received from the external network interface 125 through the management network connector 121 to the management network slot 111 of the midplane 110, so that the management traffic network signal is outputted to the management network channel; and transmits the work traffic network signal received from the external network interface 125 through the work network connector 122 to the traffic network slot 112 of the midplane 110, so that the work traffic network signal is outputted to the work network channel.

The network processing unit 126 receives the management traffic network signal from the management network channel and the work traffic network signal from the work network channel through the management network connector 121 and the work network connector 122, respectively, and outputs the management traffic network signal and the work traffic network signal through the external network interfaces 125.

In addition, the network processing unit 126 may further compose the management traffic network signal from the management network channel and the work traffic network signal from the work network channel into a traffic network signal, and output the composed traffic network signal through the external network interface 125.

In some embodiments, the external interface 125 may further comprise an external management port and a plurality of external work network interfaces. The network processing unit 126 may comprises a management processing unit and a work network processing unit.

The management network processing unit is connected to the external network interface and the management network connector 121, so that the external management network interface is coupled to the management network connector 121. The management network processing unit receives the management traffic network signal from the management network channel through the management network connector 121, and outputs the management traffic network signal through the management network interface.

The management network processing unit may acquire a media access control (MAC) address of each of the plurality of server nodes 140 through the management network channel (the management network connector 121 on the network control plane 120, the management network slot 111 and the back plate slot 116 on the middle 110 and the track splitter unit 135 and the node slot 133 on the node back plate 130), and execute an automatic IP distribution program so as to distribute an IP address according to the acquired MAC address to the corresponding one of the plurality of server nodes 140.

In some embodiments, the management network processing unit may further transmit the distributed IP address through the external management port in the external network interface 125 to the management host 300 and receive a management instruction transmitted from the management host 300 according to the received IP address. The management network processing unit may transmit the management instruction to the server node 140 having the IP address included in the management instruction to control the server node 140 operation.

The work network processing unit is connected to the external network interface and the work network connector 122, so that the work network interface is coupled to the work network connector 122. The work network processing unit receives the work traffic network signal from the work network channel through the work network connector 122, and outputs the work traffic network signal through the external work network interface. Between the work network connector 122 and the work network processing unit, a plurality of wires isolated to each other are used to connect, with each one of the wires corresponding to the work network channel associated therewith and transmitting the work traffic network signal associated therewith.

The control unit 129 may control the power module 180 and/or the fan module 190 operation. Generally, the control unit 129 may receive the node work information from some server node 140 of the management network channel through the management network connector 121, and may also receive the network instruction transmitted from the network devices external to the high density server system 100 through the external network interface 125, and control the power module 180 and/or the fan module 190 according to the received node work information and/or the network instruction. However, this is only examples, without limiting the present invention.

The node back plate 130 is plugged into a back plate slot 116 of the midplane 110. In a high density server 100, a plurality of backplanes 130 may be plugged and thus arranged.

The node back plate 130 provides a connection for the server node 140, and provides a signal transmission between the midplane 110 and the server node 140. In some embodiments the node back plate 140 also transmits the power signal transmitted from the power module 180 through the midplane 110 to the server node 140.

As shown in FIG. 1D, each of the node backplanes 130 comprises back plate pins 131, a plurality of node slots 133 and track splitter unit 135.

The back plate pins 131 are the portion through which the node back plate 130 is plugged into the back plate slot 116 of the midplane 110 and generally each takes a form of a golden finger, but which is merely an example without limiting the present invention.

Each node slot 133 provides a connection for different nodes 140, and is individually coupled to the work network channel corresponding thereto through the back plat slot 116 of the midplane 110 and coupled to the management network channel through the track splitter unit 135 and the back plate slot 116. Namely, as shown in FIG. 1E, a side of each of the node slots 133 is connected to the corresponding one of the server nodes 140, and the other side of the node slot 133 is connected to the corresponding one of the sets of pins of the back plate pins 131. The set of pins among the back plate pins 131 connecting with the node slot 133 is connected to the set of pins connecting with some work network channel of the back plate slot 116. At the same time, all the node slots 133 are connected to the track splitter unit 135, the track splitter unit 135 is connected to another set of pins of the back plate pins 131, and the set of pins of the back plate pins 131 connecting with the track splitter unit 135 is connected with the set of pins on the back plate slot 116 connecting with the management network channel.

In some embodiments, the node slot 133 is a PCI-AE slot, each comprising two sets of individual pins, with one connecting with the work network channel through the back plate slot 116 of the midplane 110 and the other the management network channel through the back plate slot 1116.

The track splitter unit 135 may determine the server nodes 140 corresponding to the received management traffic network signal, and transmit the management traffic network signal to the node slot 133 connected with the server node 140 corresponding thereto, so that the server node 140 may acquire the management traffic network signal.

In addition, when all the server nodes 140 on the node back plate 130 are removed from a side of the chassis 101, the node back plate 130 may be removed from the chassis 101.

The server node 140 is plugged onto a node slot of one of the node backplanes 130 and used to receive the work traffic network signal and the management traffic network signal generated from the node slot 133 connected therewith.

As shown in FIG. 1F, each of the server nodes 140 comprises node pins 141, a data processing unit 145 and a baseboard controller (BMC) 146.

The node pins 141 are a portion through which the server node 140 is plugged into the node back plate 130, and generally takes a form of golden fingers. However, it is merely an example without limiting the present invention.

The data processing unit 145 receives the work traffic network signal through the node slot 133 of the node back plate 130 connected with the node pins 141 and makes some required processes. After the particular processes, the node slot 133 connected with the node pins 141 transmits the work traffic network signal.

The baseboard controller 146 receives the management traffic network signal through the node slot 133 of the node back plate 130 connected with the node pins 141, and transmits the management traffic network signal through the node slot 133 connected with the node pins 141 after particular processes, which may be providing the MAC address of the network processing unit server node 140 of the network controller plate 120. However, this is merely an example without limiting the present invention.

The power module 180 is connected to the midplane 110 through a work power connector 118 on the midplane 110 at a side, and provides a power to the server mode 140 through the midplane 110 and the node back plate 130.

The fan module 190 is connected to the midplane 110 through a fan connector 119 on the midplane 110 at a side, and provides a heat venting function for the server node 114 after the fan connector 119 acquires a work power supplied from the power module 180 through the fan connector 119.

In view of the above, the high density server system of the present invention has the differences as compared to the prior art that, for those work networks having a relatively larger load, each of the server nodes on the node back plate and the midplane has its separate information transmission channel without any interference to one another, assuring that the network of every such node has a sufficient bandwidth and the sever has an guaranteed network transmission speed. For those management networks having a relatively smaller data amount, the server adopts an appropriate track-incorporation means, reducing a space taken up by the transmission tracks. By means of the technical means of the present invention, the issue that transmission bandwidth and reliability for the server nodes in the high density server system may not be assured encountered in the prior art may be well overcome, and the technical efficacies of assured overall network transmission speed of the server and reduced space taken up by the transmission tracks may be secured.

Furthermore, the method of managing a high density server may be implemented in a hardware, software or a combination of hardware and software, or in some discrete computer systems connected with one another in a discrete manner.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A high density server system, comprising:
a chassis,
a midplane, fixed within the chassis and having a plurality of back plate slots, a management network slot, a traffic network slot, and a plurality of signal conductive tracks, each of the plurality back plate slots comprising a plurality sets of traffic network channel pins and a set of management network channel pins, the signal conductive tracks connecting the plurality sets of traffic network channel pins with the traffic network slot to create a plurality of traffic network channels, and connecting the set of management network channel pins with the management network slot to generate a management network channel which is isolated form the traffic network channels;
a network control plane, at least having an external network interface, a network processing network, a management network connector and a work network connector, the management network connector and the work network connector being plugged into the management network slot and traffic network slot, respectively, the network processing unit outputting a work traffic network signal and a management traffic network signal through the work network connector and the management network connector to the work network channel and management network channel after receiving the work traffic network signal and management traffic network signal from the external network interface, and further receiving the work traffic network signal and the management traffic network signal from the work network channel and the management network channel and outputting the traffic network signal and the management traffic network signal through the external network interface;
a plurality of node backplanes, each being plugged into one of the plurality of back plate slots corresponding thereto, and each comprising a plurality of node slots and a track splitter unit, each of the plurality of node slots being coupled individually to the work network channel corresponding thereto within the back plate slot, the management network channel within the back plate slot being coupled to each of the plurality of node slots through the track splitter unit; and
a plurality of server nodes, each being plugged into one of the plurality of node slots corresponding thereto, comprising an data processing unit and a baseboard management controller, the data processing unit receiving and transmitting the work traffic network signal within the work network channel through the one of the plurality of node slots corresponding thereto and the baseboard management controller receiving and transmitting the management network signal by the management network channel through the one of the plurality of node slots corresponding thereto.

2. The high density server system as claimed in claim 1, wherein the node back plate is allowed to be removed from a side of the chassis after all of the plurality of sever nodes on the node back plate are removed from the node back plate at the other side of the chassis.

3. The high density server system as claimed in claim 1, wherein each of the plurality of node slots is a PCI-E slot having a first and second sets of individual pins connected to the traffic network channel and the management network channel, respectively, and the data processing unit receives and transmits the traffic network signal through the first individual pins connected to the traffic network channel, while the baseboard management controller receives and transmits the management network signal through the second individual pins connected to the manage network channel.

4. The high density server system as claimed in claim 1, wherein the external network interface further comprises an external management network port and a plurality of external traffic network ports, and the network processing unit further comprises a management network processing unit via which the external management network port connects to the management network connector and a traffic network processing unit via which the plurality of external traffic network ports connects to the traffic connector, the transmission paths between each of the plurality of external network ports and the traffic network processing unit are isolated from each another.

5. The high density server system as claimed in claim 4, wherein the high density server system further comprises a power module disposed at a side of the middle plate for supplying a power to the plurality of server nodes through the middle plate and each of the plurality of backplanes.

6. The high density server system as claimed in claim 5, wherein the network control plate further comprises a control unit connected to the management processing unit and controlling the power module according to one of the node operation information collected from the baseboard management controller of each of the plurality of server nodes transmitted from the management network channel and a network command received from the external management port.

7. The high density server system as claimed in claim 6, further comprises a fan module disposed at a side of the middle plate for heat dissipation for each of the plurality of server nodes, and the control unit may further control the fan module according to one of the node operation information collected from the baseboard management controller of each of the plurality of server nodes transmitted from the management network channel and a network command received from the external management port.

8. The high density server system as claimed in claim 4, wherein the management network processing unit acquires a media access control (MAC) address of each of the plurality of server nodes through the baseboard management controller of each of the plurality of server nodes and executes an automatic address distribution program to distribute an IP address to each of the plurality of server nodes according to the MAC address and transmits the distributed IP address information through the external management network port to a management host.

9. The high density server system as claimed in claim 8, wherein the management host transmits a management command comprising the IP address, and the management network processing unit transmits the management command to one of the plurality of server nodes corresponding thereto through the management network channel corresponding thereto, so as to control the operation of the one of the plurality of server nodes.
